(19) United States
(12) Patent Application Publication
(10) Pub. No.: US 2009/0071883 A1
(43) Pub. Date: Mar. 19, 2009

(54) ELECTROLYTIC SYSTEM FOR OBTAINING A DISINFECTANT

(76) Inventor: Luis C. GOMEZ, Hollywood, FL (US)

Correspondence Address: BROWDY AND NEIMARK, P.L.L.C.;624 NINTH STREET, NW, SUITE 300, WASHINGTON, DC, 20001-5303, US

(21) Appl. No.: 12/168,630

(22) Filed: Jul. 7, 2008

Related U.S. Application Data
(60) Provisional application No. 60/948,022, filed on Jul. 5, 2007.

(51) Int. Cl. C02F 1/467; B01D 21/30; C02F 103/00

(52) U.S. Cl. 210/137

(57) ABSTRACT

An electrolytic system for obtaining a disinfectant and/or sterilant is disclosed. The system comprises, among other components, at least one reaction cell, that contains a selectively permeable membrane placed between two electrodes that generate a charged field across the cell when dilute electrolytic solutions are passed through the cell. The cell is split between the electrodes by a cationic exchange membrane, which divides the reactor into an anodic chamber and a cathodic chamber. In the reaction cell, a diluted salt solution is fed separately to both chambers that electrically dissociates the same, in order that when the salt solution used is a sodium chloride solution, an aqueous solution of O₃, O₂, H₂O₂, HClO, Cl₂, HCl, H⁺, H3O⁺, OH⁻ and ClO is formed in the anodic chamber. The solution obtained in the anodic chamber being useful as a disinfectant.

### FIELD OF THE INVENTION

The present invention relates to techniques employed in the field of electrolytic processes, and more particularly, it is related to an electro-catalytic system for generating a disinfectant and or sterilant that can be used for treating liquid or solid surfaces including: waste water, reuse water, recreational waters, drinkable water, irrigation water, inanimate surfaces, foods, fruits, vegetables, residential, agricultural and animal operations, health and hospital settings, and industrial facilities and products, including wastes.

### BACKGROUND OF THE INVENTION

It is widely known that water and other consumption products used in most of human activities should comply with strict quality standards, particularly when said products are used for household activities or direct consumption, as drinking water or foods, or when such product comes into direct human or animal contact and influences the over all health and quality of life; wherein the elimination of bacteria, viruses, germs and other pathogens from water is necessary.

In this regard, most of the conventional disinfection, sterilization, and purification processes require the use of physical or chemical disinfectants. However, in most cases, an operator should handle directly the chemicals, which frequently are dangerous for human health. Chlorine gas or hypochlorite solution are a pair of chemicals frequently used in disinfection, which are cheap but hazardous. On the other hand, ozone is another chemical used for disinfecting water, but it is expensive and effective in certain conditions and also is a cause of concern for human health.

In addition, in the prior art there are disclosed physical disinfection processes based on the application of ultra violet rays, pressure or radiation; these processes are effective but expensive and require specialized application equipment.

On the other hand, the use of electrolytic processes is an alternative manner to carry out sterilization and/or disinfection. In this kind of process, water containing dissolved salts is dissociated with the purpose of forming highly oxidizing and reducing agents that eliminate the organic material present in the water.

One of those processes and its corresponding device is disclosed in the European patent application No. 0 885 849, wherein raw water is treated by the simultaneous oxidizing action of disinfecting agents, such as atomic oxygen, carbonic acid and hydrated ions of hydrogen peroxide. Particularly, said device comprises a pair of electrolysers with a cationic exchange membrane, dividing each reactor in an anodic chamber and a cathodic chamber. The electrolysers are linked together so that the anodic chamber outlet of the first electrolyser is connected to the anodic and cathodic chamber inlets of the second electrolyser. In order to produce said agents, a solution of sodium hydrocarbonate is added into the anodic chamber of both electrolysers, obtaining drinking water from the cathodic chamber thereof.

However, inasmuch as the concentration of the sodium hydrocarbonate solution fed to the first electrolyser is different to that fed to the second electrolyser, a vessel for each solution is required. In addition, said device does not include filtering means for particles that may be contained in raw water; in some cases said particles may damage the membrane of an electrolytic reactor. Finally, this device does not include storage means for the oxidizing agents produced by electrolysis, therefore they can not be dosed to others water systems outside the device.

On the other hand, a water treatment system for sterilizing water through electrolysis is disclosed in US patent application publication No. US 2003/0029808 A1, wherein the system comprising: a circulation process line for pumping the to be sterilized water out of a water container, sterilizing the water through electrolysis, and feeding the sterilized water back into the water container; means for producing a sterilizing solution having a sterilizing function by electrolyzing an electrolytic solution containing chlorine ions and having a function of promoting an electrochemical reaction; and, means for supplying the produced sterilizing solution into the circulation process line as required.

The system can constantly sterilize the water in the circulation process line and, as required, additionally supply the sterilizing solution produced by the sterilizing solution producing means into the circulation process line according to a variation in the quality of the water. Thus, the quality of the water in the water container can properly be maintained.

However, this kind of systems requires the use of fixed installations, such as storage means for containing the water to be sterilized and the sterilized water, which reduce the flexibility of the system.

In this regard, it is very important to construct a flexible system which product obtained can be produced on demand efficiently and be used on site or remotely for disinfection and/or sterilization applications such as vegetable and fruit disinfection or water disinfection including drinking water, treatment of municipal water suppliers, swimming pool disinfection, sanitary system disinfection, industrial disinfection etc.

Consequently, for long it has been sought to overcome the inconveniences of prior art electrolytic methods and devices for sterilization, by developing an electrolytic system for obtaining a disinfectant, wherein the electrolytic reactor is protected against fouling and the disinfectant is stored in order to be dosed outside the system.

### SUMMARY AND OBJECTS OF THE INVENTION

Having in mind the prior art drawbacks, it has been developed a system for obtaining a disinfectant, comprising means for altering the molecular state of a fresh water stream that is fed to said altering means; means for pumping an aqueous alkaline metal salt solution from a salt solution source; a mixer in flow communication with the altering means and the pumping means in order to receive and mix the altered water stream with the salt solution, the mixer having an input and an output; a flow regulator for receiving the mixed stream coming out of said mixer; a reaction cell in flow communication with the flow regulator; and, a controller.

The anion part of the alkaline metal salt is an element selected form the group consisting of fluorine, chlorine, bromine and iodine, and the alkaline metal is an element selected from the group IIA.

The core of the system is the reaction cell, which has a cationic exchange membrane that divides said reaction cell in a cathodic chamber and an anodic chamber; the reaction cell is fed with the mixed stream by the flow regulator and performs an electrically motivated chemical disruption of the mixed stream for producing a mix of substances in electrochemical isotopic state. After the chemical disruption, an oxidant product is obtained in the anodic chamber, whereas an alkaline solution is obtained in the cathodic chamber, the oxidant product being the disinfectant.

Finally, the system for obtaining a disinfectant of the present invention as was mentioned above comprises a controller electronically connected to the reaction cell for supplying electrical current for the chemical disruption.

In a preferred embodiment of the present invention, the system also comprises a flush line connected in a by-pass manner at the input and the exit of the mixer, the flush line allowing fresh water to directly flow through the flow regulator for cleaning the reactor cell before the electrical disruption. In this regard, both the anodic chamber and the cathodic chamber includes waste lines for disposing the fluid passing through the reaction cell during the cleaning operation or when the controller detects reaction cell operating parameters out of predetermined values.

From the above mentioned, an object of the present invention is to provide an electrolytic system for obtaining a potent disinfectant, wherein dangerous chemicals are not used.

An additional object of the present invention is to provide an electrolytic system for obtaining a disinfectant, including altering means for conditioning the molecules of water that is fed to the system.

A further object of the present invention is to provide an electrolytic system for obtaining a disinfectant, wherein the obtained disinfectant can be stored and used in dosed to diverse water systems.

### BRIEF DESCRIPTION OF THE DRAWINGS

The novel features of the present invention are set forth with particularity in the appended claims. The invention itself, however, both for its organization and for its operating method, together with further objects and advantages of the invention, will be best understood by reference to the following description of a specific embodiment, when taken in conjunction with the accompanying drawing, in which:

FIG. 1 is a schematic view of the electrolytic system for obtaining a disinfectant, built according to the principles of the present invention.

FIG. 2 is a perspective view of a reaction cell used in the preferred embodiment of the present invention.

FIG. 3 is a bar graphic showing the incidence of soft rot tomato fruit treated with the disinfectant of the present invention.

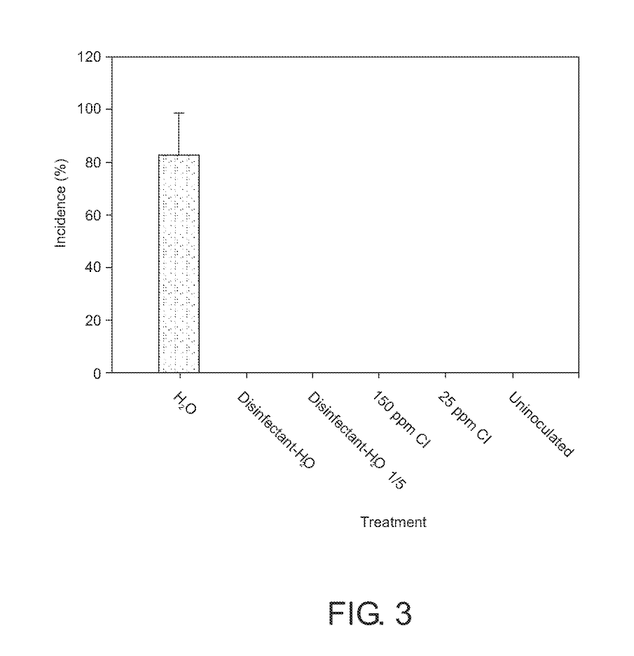

FIG. 4 is a bar graphic showing the incidence of sour rot tomato fruit treated with the disinfectant of the present invention

### DETAILED DESCRIPTION OF THE INVENTION

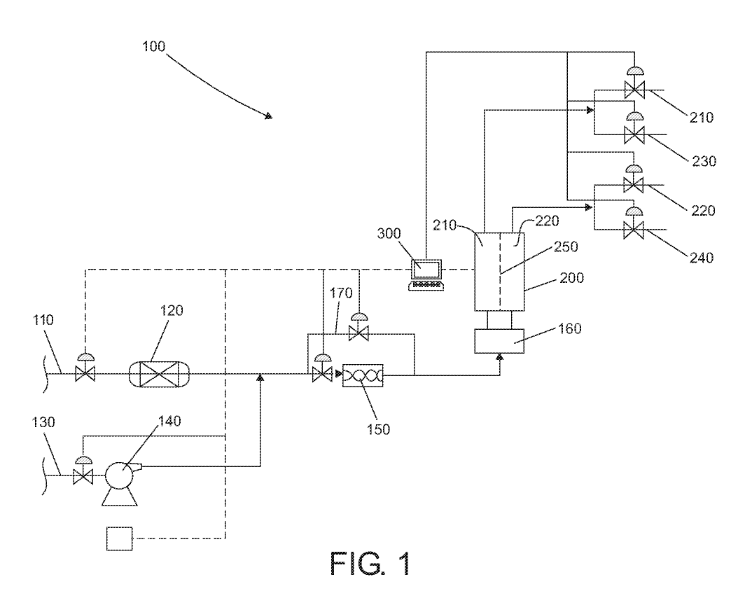

Referring in detail to the accompanying drawing, in FIG. 1 is shown an electrolytic system 100 for obtaining a disinfectant, built in accordance to a first preferred embodiment of the present invention, wherein a fresh water stream 110 is fed to altering means that, in the present embodiment is an Aqualizer™ apparatus 120, this apparatus conditions the fresh water stream molecules in an altered state which does better prepare the same for feeding a reaction cell 200. The Aqualizer™ apparatus 120 will be disclosed some paragraphs below.

A pump 140 drives an aqueous sodium chloride solution stream 130 from a salt solution source, the sodium chloride solution is sent to a mixer 150 in flow communication with the altering means 120 and the pump 140 in order to receive and mix the altered water stream with the salt solution.

A flow regulator 160 receives the mixed stream coming out of said mixer 150. After the flow regulator 160, there is the reaction cell 200 in flow communication with the same. The reaction cell 160 has a cationic exchange membrane 250 that divides said reaction cell in a cathodic chamber 210 and an anodic chamber 220. The reaction cell 200 is fed with the mixed stream by said flow regulator 160 and performs an electrically motivated chemical disruption of the mixed stream for producing a mix of substances in electrochemical isotopic state. After the chemical disruption, an oxidant product is obtained in the anodic chamber 220, whereas an alkaline solution is obtained in the cathodic chamber 210, the oxidant product being the disinfectant. The products of the cathodic chamber 210 and the anodic chamber 220 are collected in the products lines 210 and 220.

In FIG. 1, it is also observed a flush line 170 for washing the flow regulator 160 and the reaction cell 200. In this regard, there are also provided waste lines 230 and 240 for disposing the fluid passing through the reaction cell 200 while the reaction cell operating parameters are not met and for disposing waste fluids during the washing operation.

Finally, a controller 300 is electronically connected to the reaction cell 200 for supplying electrical current to the same and for controlling all the operations of the system 100. The control system 300 is preferably a computer controller which is programmed to monitor and self regulate all the functions of the electrolytic system. Monitoring the reaction cell power, monitoring the speed of the pump 140 and switching the valves of the waste lines output 230 and 240 and product lines output 210 and 220 are among the list of functions integrated into the computer controller system.

The salt solution stream 130 used in the embodiment that is described is a sodium chloride solution, preferably salt water, also known as brine or marine water; however, for preparing the salt solution also can be used any salt formed by an alkaline metal of the group IIA with an element of the group VIIA, selected from the group comprising fluorine, chlorine, bromine and iodine.

The fresh water can be obtained from any inland water source and should be filtered prior to enter into the electrolytic system 100 in order to maintain the water stream free of gross debris. The fresh water also should not have high concentrations of salt compounds dissolved in it; however, it can have solutes which may produce a colloidal suspension on a chemical scale.

It is worth mentioning that once the fresh water passes through the apparatus 120, the water stream 110 is conducted to the mixer 150 for mixing the fresh water and the salt solution arising from the pump 140. Once the fresh water and the salt solution are mixed, the mixed stream is conducted to the flow regulator 160 prior to enter into the reaction cell 200.

On the other hand, the flush line 170 is by-passed prior to entering into the mixer 150 and it is interconnected at the exit of the same, in order that when it is required, the fresh water, which is now conducted through the flush line 170, is used for washing the flow regulator 160 and the reaction cell 200. The waste water obtained during the washing is disposed through the waste lines 230 and 240 and sent to the drainage.

The apparatus 120 used preferably in the present embodiment is an Aqualizer™ apparatus patented under U.S. Pat. No. 6,712,050. The Aqualizer™ apparatus is a unique metal alloy engineered and encased to condition the fresh water molecules through its own process. The apparatus of patent '050 was created for improving the combustion efficiency in internal combustion systems, however it was found out a non-expected application in the present invention. The device of patent '050 comprises a casing having an inlet and an outlet at its ends for receiving and discharging, respectively, a liquid fuel to be treated; an elongated metal bar is concentrically located within said casing between said inlet and said outlet to enter into direct contact with the liquid fuel. The metal bar is made of an alloy comprising, by weight, 40-70% cooper, 10-32% nickel, 15-40% zinc, 2-20% tin and 0.05-10% silver. A sleeve is concentrically situated between the casing and the elongated metal bar; separation means are concentrically located between the casing and the sleeve to isolate the casing from the sleeve; interconnecting means are attached to the inlet and the outlet to interconnect the device with a fuel supply source. The apparatus also comprises fixing means situated inside each end of the casing to hold the metal bar in place; grounding means are located at the outer surface of the casing to ground the apparatus when in use, to thus protect the reaction of the liquid fuel and the metal bar from any interference caused by magnetic fields generated by any electric supply source; and a plastic film covering each end of the casing for electrically insulating said ends.

In the present invention, it was surprisingly found out that the Aqualizer™ apparatus modifies the water molecules exiting the apparatus 120 in an altered state which does better prepare the same for the reaction cell 200.

An important part of this system is the pump 140, which permits conduct the salt solution stream 130 from a salt solution source, such as a vessel, to the mixer 150, preferably said pump 140 is a centrifugal pump capable of handling saline solutions.

Once the solution has been mixed at the mixer 150, the same is conducted to the flow regulator 160 and it is sent to the reaction cell 200. It is important mentioning that the flow of the mixed stream that enters to the reaction cell is controlled by the flow regulator 160, which regulates the flow of fluid at the entrance points of the reaction cell 200 within the tolerance of the operating parameters of said reaction cell.

The reaction cell 200 is a physical chamber in which an electrically motivated chemical disruption, re-association and division of the input salt fluid occurs. The process within the reaction cell 200 produces a mix of substances in electrochemical isotopic states. The reactor produces mixed oxidants from the salt by the application of an electrical potential or charge between two chambers separated by the selectively permeable membrane. The oxidants and the alkaline products are formed from the same salt solution in two individual chambers in the reactor. The chambers are separated by a special designed membrane allowing the charge through and separating the salt solution in two branches; therefore, one portion of the ionic constituent of salt solution can be electrically transformed to the oxidant product side, whereas the other portion is transformed to the other side of the membrane and forms the alkaline solution.

In the reaction cell 200, the chemical structure of the salt solution is broken, producing the following reactive molecules and free ions, as it is indicated in table 1.

TABLE 1

| | Reactive Molecules | Free Radicals |
|---|---|---|
| Anode Chamber (+) 220 | O₃, O₂, H₂O₂, HClO, Cl₂, | H⁺, H3O⁺, |
| | HCl | OH⁻, ClO⁻ |
| Cathode Chamber (−) 210 | H₂O₂, NaOH, H₂ | OH⁻, Na⁺ |

All of the compounds listed in Table 1 are separated in its respective chamber by means of the cationic exchange membrane. Particularly, the compounds in the anodic chamber form the oxidizing disinfectant product. With regard to the reaction cell 200, the same is constructed of polypropylene and the cationic exchange membrane is made of a cationic exchange polymer.

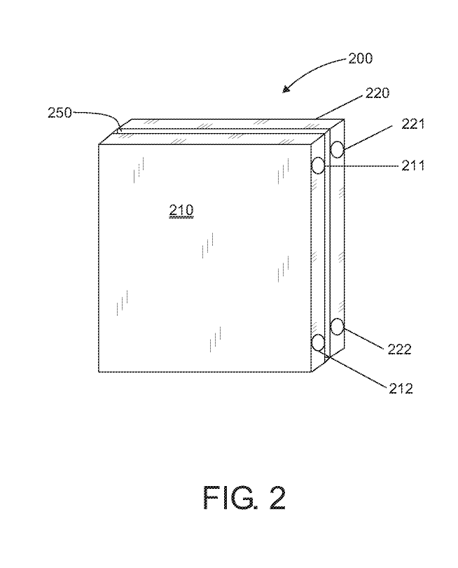

FIG. 2, shows a frontal perspective view of the reaction cell 200 used in the preferred embodiment of the present invention; both the cathodic chamber 210 and the anodic chamber 220 have an inlet 211 and 222 respectively, and an outlet 212 and 222 respectively. Inside the reaction cell 200 there is a cationic exchange membrane 150, which is in the form of plate.

Referring back to FIG. 1, it should be mentioned, that after the production of the disinfectant, that is to say after the chemical disruption, the flush line 170 is activated by the control system 300, which opens a corresponding valve in order to permit fresh water to flow through the flush line 170 and the reaction cell 200, cleaning all components before the reactor cell and the chambers of the same.

Now, having disclosed the main parts of the system 100, its operation is disclosed herein below:

Firstly, the system receives a fresh water stream 110 that is conditioned by the Aqualizer™ apparatus 120, and is conducted toward the mixer 150. The pump 140 suctions the saline solution from the salt solution stream 130 and is discharged at the mixer 150 in order to dilute the salt solution stream 130 with the water stream 110.

Once the salt solution has been diluted, the same is fed to the flow regulator 160 which controls the saline solution that enters to the reaction cell 200. The flow regulator 160 regulates the flow of fluid at the entrance points of the reaction cell 200 within the tolerance of the operating parameters of said reaction cell

In each chamber of the reaction cell 200, electrical current is supplied from the control system 300, dissociating the saline solution, so that O₃, O₂, H₂O₂, HClO, Cl₂, HCl, H⁺, H3O⁺, OH⁻, ClO⁻ are formed in the anodic chamber of the reactor and H₂O₂, NaOH, H₂, OH⁻, Na⁺ are formed in the cathodic chamber of the reaction cell 200.

The content of the anodic chamber is conducted to the product line 210 in order to be used as an oxidizer and/or disinfectant that can be employed in many applications such as those previously mentioned at the beginning of the present description.

Meanwhile, the content of the cathodic chamber passes through the product line 220 and is sent outside the system. This solution obtained is a soap-like solution that can be used for cleaning and disinfecting purposes. The solution has an elevated pH (>11) and thus is very basic and has a soapy texture. It has been effectively used in numerous cleaning applications including but not limited to: windows, bathrooms, floors and surfaces of restaurants, health clinics, hotels, sports and recreation areas, residential, and public outdoor area.

Once the cycle is terminated, the control system activates the flush line 170, allowing the water stream 110 to flow through the reaction cell 200 for washing the inner parts of the reaction cell. With this cleaning operation, the production cycle of the disinfectant is ended.

The following examples are destined to illustrate the scope of the present invention in all aspects, which are present with illustrative purposes but they do not restrict it:

### EXAMPLE 1

A sample of water containing biological material in dangerous levels for human health was treated with the disinfectant obtained with the electrolytic system of the present invention.

The main quality parameters measured before and after said treatment are shown in Table 2:

TABLE 2

| | | |
|---|---|---|
| | | Sample after treatment; |
| | Sample | (disinfectant dosed in a |
| Parameter | before treatment | proportion of 1:2000) |

| | | | |
|---|---|---|---|
| Amount of chlorine | 0 ppm | 0.4 | ppm |
| Coliform Germs total | Many countless | 0 in 100 | ml |
| Fecal Coliforms total | Many countless | 0 in 100 | ml |
| Fecal Streptococcus total | 6 | 0 in 100 | ml |
| Germs total 37° in 1 ml | Many countless | 15 in 1 | ml |

According to the above results, it can be observed that water obtained after disinfecting treatment is suitable for drinking.

### EXAMPLE 2

River water was treated with the disinfectant obtained with the electrolytic system of the present invention. Some parameters concerning biological material present in water were measured before and after the treatment; they are shown in Table 3:

TABLE 3

| | Colony by | | | Coliforms | Fecal |
|---|---|---|---|---|---|
| | 44 +/− 4 h | | E. Coli in | germs | streptococcus |
| | 20° and 36° | | 100 ml | 100 ml | 100 ml |
| River water | 300 | 250 | Evident | Evident | Evident |
| before | | | | | |
| treatment | | | | | |
| Treated | 6 | 1 | Not evident | Not evident | Not evident |
| water with | | | | | |
| disinfectant | | | | | |
| 1:500 | | | | | |
| Treated | 4 | 2 | Not evident | Not evident | Not evident |
| water with | | | | | |
| disinfectant | | | | | |
| 1:800 | | | | | |
| Treated | 2 | 7 | Not evident | Not evident | Evident |
| water with | | | | | |
| disinfectant | | | | | |
| 1:1000 | | | | | |

### EXAMPLE 3

The disinfectant obtained with the electrolytic system of the present invention was dosed in a household water sample in a proportion of 1:800 (disinfectant/water).

The main parameters measured before and after the treatment are shown in Table 4:

TABLE 4

| | Before treatment | | After treatment | |
|---|---|---|---|---|
| Particles in water | 32 | mg/l | 31 | mg/l |
| DQO | 94 | mgO₂/l | 119 | mgO₂/l |
| DBO | 36 | mgO₂/l | 6 | mgO₂/l |
| Conductivity | 11.93 | m/s | 15.83 | m/s |

| pH | 7.14 | 3.14 | |
|---|---|---|---|
| Counting of Coliforms | 230 000 Colonies/100 ml | 0 in 100 | ml. |
| Fecal Germs | | | |

### EXAMPLE 4

Another sample of household water was treated with the disinfectant obtained with the system of the present invention. The results before and after the treatment are shown in the Table 5:

TABLE 5

| | Before treatment | | After treatment | |
|---|---|---|---|---|
| Counting of Coliforms | 64 in 100 | ml | 0 in 100 | ml |
| Counting of Coliforms Fecal | 10 in 100 | ml | 0 in 100 | ml |
| Counting of Streptococcus | 8 in 100 | ml | 0 in 100 | ml |
| Fecals | | | | |
| DQO | 48 | mg O₂/l | 44 | mg O₂/l |
| DBO5 | <10 | mg O₂/l | <10 | mg O₂/l |
| Particles in water | 21 | mg/l | <10 | mg/l |

### EXAMPLE 5

An additional sample of household water was treated with the disinfectant obtained with the system of the present invention. The results before and after the treatment are shown in Table 6:

TABLE 6

| | Before treatment | | After treatment | |
|---|---|---|---|---|
| Counting of Coliforms | 230 in 100 | ml | <3 in 100 | ml |
| Counting of Coliforms Fecal | 3.6 in 100 | ml | <3 in 100 | ml |
| Counting of Aerobes | 30 in 1 | ml | 20 in 1 | ml |
| E. coli | 3.6 in 100 | ml | 0 in 100 | ml |
| Chlorine | 0 | | 0 | |

### EXAMPLE 6

In order to measure the effectiveness of the disinfectant obtained in the present invention, a test related with reduction of germs was carried out using colonies of the microorganism known as Pseudomonas aeruginosa, the result are illustrated in the Tables 7 and 8.

TABLE 7
Pseudomonas to 24 h 36° C. per 100 ml

| Dilution | |
|---|---|
| (Disinfectant/water) | |
| 1:1000 | 1:500 |

Duration of action

| Start Value | 30 s | 5 min | 30 s | 5 min |
|---|---|---|---|---|
| 2,600,00 | 12,400 | 8,400 | 1,100 | 400 |

TABLE 8
Pseudomonas 24 h to 36° C. per 100 ml

| Dilution | |
|---|---|
| (Disinfectant/water) | |
| 1:1000 | 1:500 |

Duration of action

| Start Value | 30 s | 5 min | 30 s | 5 min |
|---|---|---|---|---|
| 160,000 | n.n* | n.n. | n.n. | n.n. |
| 1,600,000 | 13,200 | 9,200 | n.n | n.n |
| 2,800,000 | 1,100 | n.n | n.n | n.n |

n.n*. = Not found/Not evident

### EXAMPLE 7

Well raw water, river raw water and casino raw water were treated with the disinfectant obtained with the present invention. Some parameters concerning biological material present in water were measured before and after the treatment; they are shown in Tables 9, 10 and 11:

TABLE 9
(Well raw water)

| | Before treatment | | After treatment | |
|---|---|---|---|---|
| pH | 7.79 | | 7.37 | |
| Aerobic Plate Count | >73.8 | MPN/ml | 60 | MPN/ml |
| Calcium | 300 | mg/lt | 26 | mg/lt |
| Hardness, Calcium | 750 | mg/lt | 66 | mg/lt |
| (as CaCO₃) | | | | |
| Iron | 0.21 | mg/lt | 0.11 | mg/lt |
| Sodium | 700 | mg/lt | 190 | mg/lt |

TABLE 10
(River raw water)

| | Before treatment | | After treatment | |
|---|---|---|---|---|
| pH | 7.96 | | 7.72 | |
| Aerobic Plate Count | >73.8 | MPN/ml | 0.2 | MPN/ml |
| Calcium | 170 | mg/lt | 50 | mg/lt |
| Hardness, Calcium | 420 | mg/lt | 130 | mg/lt |
| (as CaCO₃) | | | | |
| Iron | <0.050 | mg/lt | <0.050 | mg/lt |
| Sodium | 220 | mg/lt | 180 | mg/lt |

TABLE 11
(Casino raw water)

| | Before treatment | | After treatment | |
|---|---|---|---|---|
| pH | 8.06 | | 7.64 | mg/l |
| Aerobic Plate Count | >73.8 | MPN/ml | 50 | MPN/ml |
| Calcium | 130 | mg/lt | 26 | mg/lt |
| Hardness, Calcium | 320 | mg/lt | 65 | mg/lt |
| (as CaCO₃) | | | | |
| Iron | 0.13 | mg/lt | 0.059 | mg/lt |
| Sodium | 120 | mg/lt | 200 | mg/lt |

### EXAMPLE 8

Staphylococcus aureus and E. coli challenge Staphylococcus aureus (ATCC 1200) and E. coli (ATCC 15597) stock cultures were obtained from American Type Culture Collection and were maintained at −80° C. For challenge experiments, overnight cultures from the frozen stocks were grown in 10 ml of Tryptic Soy Broth (TSB, Beckton Dickinson, MD) at 36° C. prior to the date of the experiments. At the day of challenge, the broth cultures were centrifuged at 3K×G for 5 minutes and suspended in 10 ml of phosphate buffered saline (PBS, Fisher scientific, PA).

20 ml of PBS and 20 ml of the disinfectant were placed in 50 ml conical bottom polypropylene tubes (Fisher scientific, PA). To each of the tubes, approximately 2.3×10⁶ of Staphylococcus aureus was added and the tubes were agitated rapidly. At, 10, 30, 60, 180 and 300 seconds following the addition of the bacteria, 1 ml aliquots of PBS and the disinfectant were removed and placed in 9 ml of PBS containing 0.02% sodium thiosulfate. The microorganisms in each of the dilution tubes were enumerated by spread plating onto plate count agar (PCA, Beckton Dickinson, MD) and incubated at 37° C. for 24 hours. The same experiment was repeated using E. coli. Tables 12 and 13 contain the results of the above-mentioned test.

TABLE 12
Reduction of S. aureus

| | Colony Forming Units (CFU) ml of | | | | |
|---|---|---|---|---|---|
| | S. aureus at the below time points. | | | | |
| | | | | 180 | 300 |
| SAMPLE | 10 sec | 30 sec | 60 sec | seconds | seconds |
| PBS | 1.8 × 10⁵ | 9.7 × 10⁵ | 1.1 × 10⁵ | 1.0 × 10⁵ | 1.6 × 10⁵ |
| Disinfectant | <10 | <10 | <10 | <10 | <10 |

TABLE 13
Reduction of E. coli

| | Colony Forming Units (CFU) ml | | | | |
|---|---|---|---|---|---|
| | of E. coli at the below time points. | | | | |
| SAMPLE | 10 sec | 30 sec | 60 sec | 3 minutes | 5 minutes |
| PBS | 3.2 × 10⁵ | 5.8 × 10⁵ | 4.7 × 10⁵ | 2.2 × 10⁵ | 2.5 × 10⁵ |
| Disinfectant | <10 | <10 | <10 | <10 | <10 |

### EXAMPLE 9

### Bacillus subtilis Challenge Test

Bacillus subtilis (ATCC 19659) was propagated on plate count agar and tryptic soy broth (Beckton Dickinson, MD). The original ATCC strain was maintained at −80° C. A purified spore suspension of B. subtilis was produced as per ASTM E2111-00 (standard quantitative carrier test method to evaluate the bactericidal, fungicidal, mycobactericidal and sporicidal potencies of liquid chemical germicides). Spores were generated 48 hours prior to challenge.

The spore challenge studies were conducted according to the following protocol: 20 ml of sterile type 1 ASTM grade water (Rica Chemical Co., TX) and 20 ml of the various dilutions of disinfectant solutions of the present invention were placed in sterile 50 ml conical bottom polypropylene tubes (Fisher scientific, PA). The disinfectant was generated on site by the system of the present invention and immediately prior to the challenge.

Dilutions of the disinfectant were prepared in ASTM type I deionized water. To each of the water or disinfectant challenge tubes, approximately 1.0×10⁶ of the above purified spore suspension was added. The tubes were then inverted repeatedly at a moderated-slow speed for 60 seconds. Following the exposure, a 100 μl aliquots of solution were removed and placed in 10 of neutralizing broth (Beckton Dickinson, MD). The spores in the dilution tubes were then enumerated by spread plating onto plate count agar (Beckton Dickinson, MD). The plates were then incubated at 37° C. for 48 hours and the colonies were enumerated. All analyses were conducted in duplicates and experiments were repeated to verify results. Table 14 contains the results of the above-mentioned test:

TABLE 14
Reduction of Bacillus subtilis spores (ATCC 19659)

| | B. subtilis spore concentration | |
|---|---|---|
| Sample | (cfu/ml in dilution buffer) | Percent reduction |
| ASTM water | 906 × 10² | NA |
| 20% Disinfectant | 5.0 | 99.5% |
| 50% Disinfectant | 1.0 × 101 | 98.8% |
| 100% Disinfectant | <0.1 | >99.98% |

### EXAMPLE 10

### Poliovirus 1 Challenge Study

Poliovirus 1 (Strain: Chat, ATCC VR-1562) was propagated on buffalo green monkey cells. Cell free viral stocks were titrated and maintained at −80° C. For challenge experiments, an aliquot of the virus stocks was thawed rapidly and maintained at 4° C. until use.

The viral challenge studies were conducted in accordance to the following laboratory protocol: 20 ml of sterile type 1 ASTM grade water (Rica Chemical Co., TX) and 20 ml of the various dilutions of the disinfectant solutions were placed in sterile 50 ml conical bottom polypropylene tubes (Fisher scientific, PA). The disinfectant was generated on site by the system of the present invention and immediately prior to the challenge

Dilutions of the disinfectant were prepared in ASTM type 1 deionized water. To each of the water of disinfectant challenge tubes, approximately 1.0×10⁶ of the above Poliovirus was added. The tubes were then inverted repeatedly at a moderated-slow speed for 60 seconds. Following the exposure, a 0.1 ml aliquots of solution was removed and placed in 10 neutralizing broth (Beckton Dickinson, MD) supplemented w/5% fetal bovine serum (Atlanta Biologicals, GA). The virus in the tubes were then enumerated on buffalo green monkey cells as plaque forming units (pfu) by an agar overlay assay as per standard methods. Various volumes and dilutions were inoculated onto the cell monolayer in T-25 cell culture flasks (Corning N.Y.). The flasks incubated at 37° C. for 72 hours and plaques were enumerated. All analyses were conducted in duplicates and experiments were repeated to verify results. Table 15 contains the results of the above-mentioned test.

TABLE 15
Reduction of Poliovirus 1 (CHAT, ATCC VR-1562)

| | Poliovirus 1 pfu/ml in the dilution | |
|---|---|---|
| Sample | buffer | Percent reduction |
| ASTM water | 50. × 10³ | NA |
| 5% Disinfectant | 1.8 × 10³ | 64% |
| 10% Disinfectant | <1.0 | >99.9% |
| 20% Disinfectant | <1.0 | >99.9% |
| 50% Disinfectant | <1.0 | >99.9% |

### EXAMPLE 11

### Inactivation of Cryptosporidium in Aqueous Solution

Live Cryptosporidium oocysts (2.5×10⁵ oocysts/ml) were obtained from Waterborne, Inc. (New Orleans, La.). Stock oocysts were suspended in Phosphate Buffered Saline (pH 7).

An aliquot of 0.25 ml of the cryptosporidium stock suspension was added to a sterile 15 ml polypropylene conical centrifuge tubes (Fisher Scientific, USA). To each tube, 5 ml of either phosphate buffered saline or 100% freshly produced bioactive was added. The tubes were gently rotated horizontally on a Dynal® agitator (ATR Inc, USA) for 1 minute or 5 minutes. The tubes were the removed from the shaker and 5 ml of neutralizing buffer (Beckton Dickinson, USA) was added to each tube. The experiment was conducted in duplicates (A and B). The oocysts in the tubes were then concentrated by immuno-magnetic separation as per EPA 1623 methodology. Concentrates were analyzed for viability by the mammalian tissue cell culture assay below using human ileocecaladenocarcinoma cells (HCT-8).

Aliquotes of Cryptosporidium oocysts were inoculated onto HCT-8 cell monolayers in 8-well chamber glass cell culture slides and incubated in a 5% CO₂ atmosphere at 37° C. for 48 hours. Viable Cryptosporidium were enumerated by the foci detection-most probable number method. Briefly, cell monolayers were fixed and stained with fluorescent-labeled antibody specific for the reproductive stages of the Cryptosporidium lifecycle (specifically sporozoites).

Infectious foci were observed by UV epifluoroescence microscopy. Individual wells were scored as positive or negative for infection and results are calculated using a most probable number (MPN) statistical analysis. Results are reported as MPN of viable oocysts per milliliter in Tables 16 and 17.

TABLE16

| | | One minute | One min. | Five minute | |
|---|---|---|---|---|---|
| | Starting Quantity | Treatment | log₁₀ | treatment | Five min. log₁₀ |
| Sample ID | (PBS Control) | (MPN | reduction | (MPN) | reduction |
| A | >1.4 × 10⁴ | 1.4 × 10³ | >1.00 | 1.5 × 10² | >1.97 |
| B | >1.4 × 10⁴ | 6.9 × 10² | >1.31 | 6.9 × 10² | >1.31 |

TABLE 17

| | | One minute | One min. | Five minute | |
|---|---|---|---|---|---|
| | Starting Quantity | Treatment | log₁₀ | treatment | Five min. log₁₀ |
| Sample ID | (PBS Control) | (MPN | reduction | (MPN) | reduction |
| A | >2.9 × 10⁴ | 1.2 × 10³ | >1.38 | 1.4 × 10² | >2.31 |
| B | >2.9 × 10⁴ | 2.8 × 10³ | >1.01 | 1.4 × 10² | >2.31 |

The reductions (>99% inactivation) of viable oocysts observed within the limited contact time of 1-5 minutes initially appears to be equally or more effective than the disinfection contact times reported in the literature using oxidizing disinfectants such as chlorine dioxide and ozone. In two published reports, exposure to 1 mg/L ozone for 5 min (maintained constant throughout) or 1.3 mg/L chlorine dioxide (initial concentration) for 60 min, achieved >90% inactivation, whereas 90 min exposure to 80 mg/L (initial concentration) of either chlorine or monochloramine was required for the same degree of inactivation Korich, D. G., Mead, J. R., Madore, M. S., Sinclair, N. A. and Sterling, C. R. 1990. “Effects of ozone, chlorine dioxide, chlorine, and monochloramine on Cryptosporidium parum oocyst viability”. Appl. Environ. Microbiol. 56:1423-1428; and in the document of Peeters, J. E., Ares Mazas, E., Masschelein, W. J., Villacorta-Martinez de Maturana, I. and Debacker, E. 1989 “Effect of disinfection of drinking water with ozone or chlorine dioxide on survival of Cryptosporidium parvum oocysts.” Appl. Environ. Microbiol. 55:1519-1522. The data allowed approximate CT values of between 5 and 10 for ozone, 78 for chlorine dioxide, and 7200 for chlorine and monochloramine to be estimated, for 99% inactivation at 25° C. in buffered (pH 7.0) denabd-free water (Korich et al., 1990).

### EXAMPLE 12

### Erwinia caratovora and Geotrichum candidum Challenge Test

The disinfectant of the present invention was tested for its ability to kill cells of Erwinia caratovora and Geotrichum candidum, the causal agents of soft and sour rot of tomato. Treatments included the disinfectant of the present invention as well as the disinfectant diluted with tap water (1/5 and 1/10 dilutions), two rates of free chlorine (50 and 150 ppm), and 5 ppm ClO₂. Cells were treated in a total volume of 5 ml in a test tube with a final concentration of 1×10⁵ cells/ml. Treatments lasted for time periods of 30, 60, and 120 seconds followed by the addition of several drops of 2N sodium thiosulfate. Serial dilutions of the samples were made and plated onto either potato dextrose agar, for G. candidum, or nutrient agar, for E. caratovora. Each treatment was repeated 2 times for a total of 3 replications. The pH, mV, free chlorine, and total chlorine were recorded for the disinfectant prior to each treatment. The pH ranged from 2.43 to 2.72. The mV ranged from 1144.7 to 1157.9. The free and total chlorine ranged from 77 to 90 ppm and 125 to 148 ppm, respectively, Results of the in vitro antimicrobial tests are shown in Tables 18 and 19. Plated were counted 2 days after planting. Results are reported in mean log cfu.

TABLE 18
Fungicidal efficacy of the disinfectant, chlorine and ClO₂ on Geotrichum candidum.
Geotrichum candidum, at a concentration of 10⁶ cells/ml.

| | | | Disinfectant | | | | |
|---|---|---|---|---|---|---|---|
| | | | diluted with | Disinfectant | | | |
| | | | H₂O | EO H₂O | 150 ppm | 50 ppm | 5 ppm |
| Time (s) | Water | Disinfectant | 1/5 | 1/10 | Cl | Cl | Cl0₂ |
| 30 | 6.2 | 0.0 | 3.9 | 6.0 | 0.0 | 3.3 | 4.9 |
| 60 | 6.2 | 0.0 | 0.0 | 6.0 | 0.0 | 2.0 | 3.7 |
| 120 | 6.2 | 0.0 | 0.0 | 5.9 | 0.0 | 2.0 | 2.4 |

TABLE 19
Bactericidal efficacy of the disinfectant, chlorine and ClO₂on Erwinia carotovora
at a concentration of 10⁶ cells/ml.

| | | | Disinfectant | | | | |
|---|---|---|---|---|---|---|---|
| | | | diluted with | Disinfectant | | | |
| | | | H₂O | EO H₂O | 150 ppm | 50 ppm | 5 ppm |
| Time (s) | Water | Disinfectant | 1/5 | 1/10 | Cl | Cl | Cl0₂ |
| 30 | 6.3 | 0.0 | 0.0 | 0.0 | 0.0 | 0.0 | 0.0 |
| 60 | 6.3 | 0.0 | 0.0 | 0.0 | 0.0 | 0.0 | 0.0 |
| 120 | 6.3 | 0.0 | 0.0 | 0.0 | 0.0 | 0.0 | 0.0 |

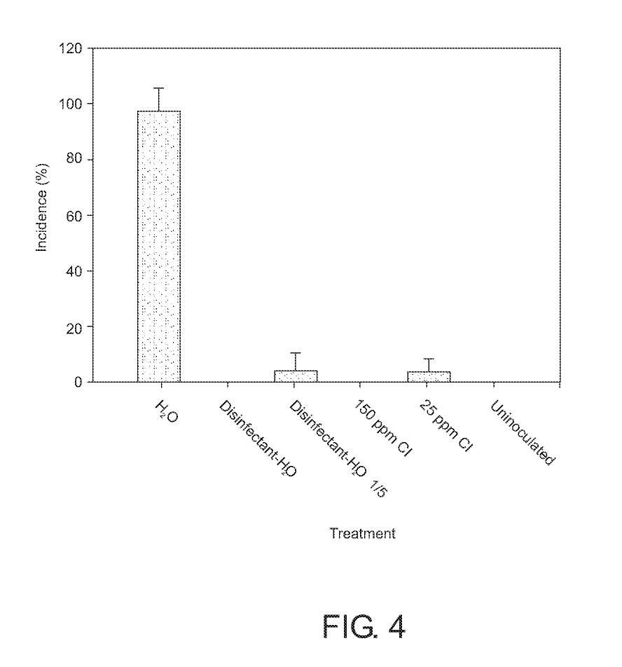

FIGS. 4 and 5 show the result measured when tomatoes were treated for 2 minutes. Incidence was recorded 4 day after treatment.

Even though in the foregoing description certain embodiments of the present invention are illustrated and described, emphasis should be made in that numerous modifications are possible to such embodiments without departing from the true scope thereof, such as including more than one reactor or varying the construction materials thereof, as well as using a saline solution with a different concentration. The present invention, therefore, should not be restricted except for that required by the prior art and by the appended claims.

What is claimed is:

1. An electrolytic system for obtaining a disinfectant comprising:
a) means for altering the molecular state of a fresh water stream that is fed to said altering means, the altering means producing an altered water stream;
b) means for pumping an aqueous alkaline metal salt solution from a salt solution source;
c) a mixer in flow communication with the altering means and the pumping means, the mixer having an inlet in order to receive and mix the altered water stream with the aqueous solution; and an outlet where a mixed stream exits;
d) a flow regulator for receiving the mixed stream coming out of said mixer;
e) a reaction cell in flow communication with the flow regulator; the reaction cell having a cationic exchange membrane that divides said reaction cell in a cathodic chamber and an anodic chamber; the reaction cell being fed with the mixed stream by said flow regulator and performing an electrically motivated chemical disruption of the mixed stream for producing a mix of substances in electrochemical isotopic state; such that, after the chemical disruption, an oxidant product is obtained in the anodic chamber, whereas an alkaline solution is obtained in the cathodic chamber, the oxidant product being the disinfectant; and,
f) a controller electronically connected to the reaction cell for supplying electrical current for the chemical disruption.

2. An electrolytic system for obtaining a disinfectant, according to claim 1, wherein the anion part of alkaline metal salt is an element selected form the group consisting of fluorine, chlorine, bromine and iodine and the alkaline metal is an element of the group IIA.

3. An electrolytic system for obtaining a disinfectant, according to claim 2, wherein the alkaline metal salt is sodium chloride.

4. An electrolytic system for obtaining a disinfectant, according to claim 1, further comprises a filter located before the altering means in order to maintain the fresh water stream free of gross debris.

5. An electrolytic system for obtaining a disinfectant, according to claim 1, wherein the fresh water is free of salt compounds dissolved in the same.

6. An electrolytic system for obtaining a disinfectant, according to claim 1, wherein the altering means is an Aqualizer™ apparatus.

7. An electrolytic system for obtaining a disinfectant, according to claim 1, wherein the pumping means is a centrifugal pump capable of handling saline solutions.

8. An electrolytic system for obtaining a disinfectant, according to claim 1, wherein, when the salt solution used is a sodium chloride solution; the oxidant product produced in the anodic chamber comprises O₃, O₂, H₂O₂, HClO, Cl₂, HCl, H⁺, H3O⁺, OH⁻ and ClO⁻.

9. An electrolytic system for obtaining a disinfectant, according to claim 1, wherein, when the salt solution used is a sodium chloride solution the alkaline solution produced in the cathodic chamber comprises H₂O₂, NaOH, H₂, OH⁻ and Na⁺.

10. An electrolytic system for obtaining a disinfectant, according to claim 1, wherein the reaction cell is made of polypropylene.

11. An electrolytic system for obtaining a disinfectant, according to claim 1, wherein the cationic exchange membrane is made of cationic exchange polymers.

12. An electrolytic system for obtaining a disinfectant, according to claim 1, wherein the cationic exchange membrane is in the form of a plate.

13. An electrolytic system for obtaining a disinfectant, according to claim 1, further comprising a flush line connected in a by-pass manner at the input and the exit of the mixer, the flush line allowing fresh water to directly flow through the flow regulator for cleaning the reactor cell before the electrical disruption.

14. An electrolytic system for obtaining a disinfectant, according to claim 1, wherein both the anodic chamber and the cathodic chamber includes waste lines for disposing the fluid passing through the reaction during the cleaning operation or when the controller detects reaction cell operating parameters out of predetermined values.
